(19) United States
(12) Patent Application Publication
(10) Pub. No.: US 2009/0012812 A1
(43) Pub. Date: Jan. 8, 2009

(54) SYSTEM AND METHOD FOR PATIENT CARE

(76) Inventors: Tracy Rausch, Waltham, MA (US); Brent Segal, Woburn, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/043,676

(22) Filed: Mar. 6, 2008

Related U.S. Application Data
(60) Provisional application No. 60/905,155, filed on Mar. 6, 2007.

(51) Int. Cl. G06Q 50/00

(52) U.S. Cl. 705/2

(57) ABSTRACT

Embodiments of the present invention may integrate and analyze the output from various medical devices and clinical information systems in order to assist the clinical staff in making the more informed clinical decisions, output intelligent alarms, predict and prevent adverse events, and in some circumstances enable automated patient care.

### CROSS-REFERENCE TO RELATED APPLICATIONS

This application claims the benefit of U.S. Provisional Application No. 60/905,155, filed on Mar. 6, 2007, which is hereby incorporated by reference as if set forth in its entirety herein.

### TECHNICAL FIELD

The present invention relates in general to the integration and interoperability of medical devices and information systems in order to provide clinical decision support.

### BACKGROUND INFORMATION

Clinicians typically monitor the status of a number of patients at the same time using electronic physiological monitoring systems and in some cases also use electronic medical charting and records systems. The majority of these systems are passive systems that do not interpret the data that they provide. These passive systems generally are not integrated with other systems and therefore leave it to the clinician to interpret data and make connections between data provided by different systems. A clinician's ability to do this with large amounts of current, past, and demographic data may be limited.

### SUMMARY OF THE INVENTION

Embodiments of the present invention may integrate and analyze the output from various medical devices and clinical information systems in order to assist the clinical staff in making the more informed clinical decisions, output intelligent alarms, predict and prevent adverse events, and in some circumstances enable more automated patient care. This may include aggregating the data from various devices into a display that may be easily interpreted by a clinician. This may include using the output from one or more monitoring devices to signal or trigger an operation by another monitoring device. For example, a trend of decreased heart rate may trigger a blood pressure check. This may include using the output from one or more monitoring devices to signal or trigger an operation by another medical care device, such as an infusion pump, a bed level control, physical apparatus, and so forth.

Although health care is a system of people helping people, the integration of the information that is available to them and control of devices that are currently in use enhances diagnostic capabilities, particularly when combined with automated safety checks and instant electronic event feedback.

Take as a simple example a patient receiving blood pressure stabilizing medication. Suppose that within a period of several minutes the patient's blood pressure begins to drop. The clinical staff is working with other patients and may not notice the change until a threshold level is crossed and the blood pressure system generates an alarm. This then requires a quick response to stabilize the patient. Alarm thresholds typically are set at thresholds indicative of a serious problem because a typical blood pressure monitor does not distinguish between normal changes in blood pressure and a problematic trend, and also because a typical blood pressure monitor does not cross-reference a patient's blood pressure with other physiological measurements such as respiration rate, heart rate and ECG. Earlier notification that a patient may be becoming unstable can save time and reduce risk.

Generally speaking, healthcare data may be characterized as one of five different types of data: demographic and patient information, waveform, discrete, alarm, and episodic. Demographic and patient information includes medical record numbers, patient name, date of birth, gender and so forth. Waveform data typically has ongoing data values, such as ECG and respiration. Discrete data typically is generated by measurements taken at discrete intervals, such as temperature, non-invasive blood pressure (NIBP), and an infusion rate. Alarm data may include preset thresholds or limits reached by the other forms of data. Episodic data would be data that is collected about a particular action taken, for example, button pushing by a patient, or an action taken by clinical staff. This data may be required to be delivered in real time (instantly/ms), near real time (<10 s), periodic (>1 min), and non-real time archival (>10 minutes, on demand). The described technology may consolidate and provide useful reporting of these various types of data.

A clinician rarely uses the measurement of a single physiological event to make a decision. The availability of these various signals and information from different systems in a single location without dependency on a particular model or manufacturer improves the ability for clinical diagnostics. Comparing the values with previous data, EMR information, and drug interaction databases may more fully utilize the power of the information in an electronic medical record.

A system may allow for the clinician to choose a procedure that they are going to perform, and/or store a customized clinician preference. The system may then utilize preset patient specific physiological waveforms and discrete data to analyze real-time data along with device generated alarms. Since patients do not typically have standard waveforms, the analysis of change of state is important in the diagnosis. Various embodiments have an ability to generate alarms on the basis of waveform, discrete, and episodic data changes. Such systems may then be capable of recalling data of specific events for clinical diagnostic purposes. This information may then be transmitted to a physician, code team, or other clinical staff.

In some embodiments, algorithms for monitoring patient status and generating alarms or events use information from one or more monitoring devices in an integrated manner. Such algorithms may be based on trends in the information, rather than simply threshold levels. Such algorithms may be based on trends in data from multiple devices. Such algorithms may be configurable on a per-patient basis, such that a clinician may be able to configure the algorithm for alarming based on the patient status. In some embodiments, a PCC may suggest or recommend configuration levels for a patient based on the patients status, the medical history of the patient, clinician preferences, best practices specified by a medical group or facility, and so forth. The configuration may be different depending on whether the event that is triggered is an alarm to a clinician, a monitoring triggering event (e.g., the taking of an ultrasound with a portable machine), and/or a medical care event (e.g., the change in rate of medicine provided by an infusion pump).

### BRIEF DESCRIPTION OF THE DRAWINGS

FIG. 1 shows a block diagram of an exemplary implementation architecture of an embodiment of the invention.

FIG. 2 shows a block diagram of an exemplary implementation architecture of an embodiment of the invention.

FIG. 3 is a patient-specific display in an embodiment of the invention.

FIG. 4 is a block diagram of a clinical decision module according to an embodiment of the invention.

FIG. 5 is a block diagram of a closed loop control module according to an embodiment of the invention.

FIG. 6 is a block diagram of a medical information systems and clinical event archiving module according to an embodiment of the invention.

### DETAILED DESCRIPTION

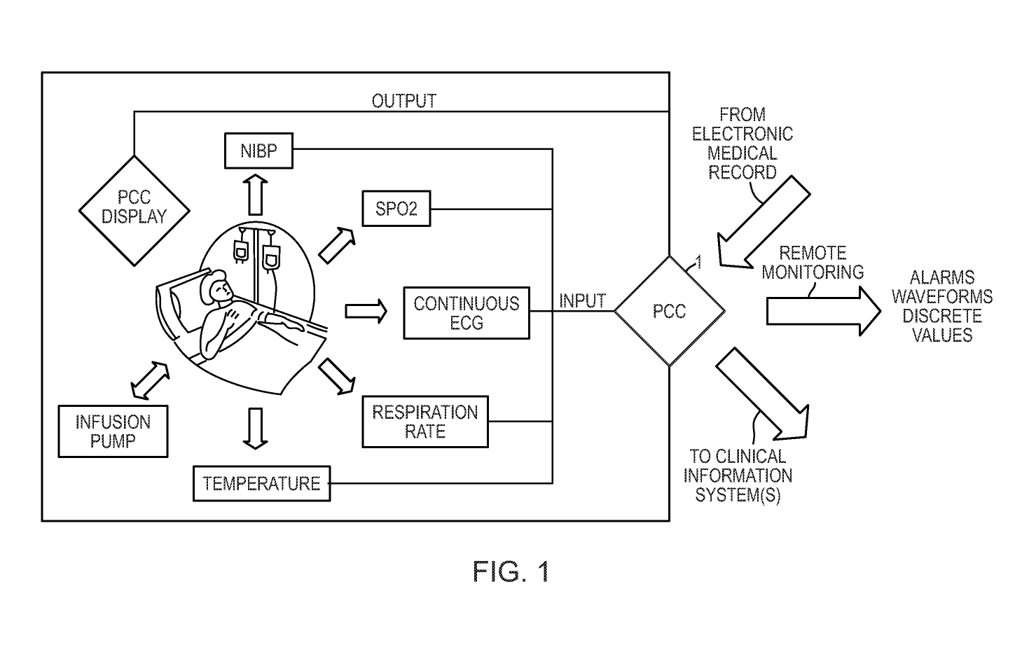

Referring to FIG. 1, a patient, typically in an inpatient setting, is monitored by a variety of medical devices, in this example, including Non-Invasive Blood Pressure (NIBP), Pulse Oximetry (SPO2), Continuous ECG (ECGcont), Respiration Rate (Resp), Temperature (Temp), and an Infusion Pump (IVᵢ). The Infusion Pump (IVᵢ) may also be a medical care device, in that it may not only monitor the status of the pump and its operation, but also may provide medical care in the form of medicine to a patient. It should be understood that the devices shown here are exemplary, and there may be any number of type of devices in a particular implementation.

A device, referred to as Patient Care Controller (PCC) 1, is interposed between these devices, and possibly one or more electronic medical record systems (EMR). The PCC may serve as a gateway from the medical devices and EMR to remote monitoring systems (RMS) and clinical information systems (CIS). The PCC 1 may communicate with each of the devices. The PCC 1 may have an interface to each of the monitoring devices. The PCC 1 may, in some embodiments, have the ability to record all of the data that is provided by the various devices, so that a clinician may review the data provided by each of the devices, and see how it has changed over time. The PCC 1 may, in some embodiments, have the ability to control one or more of the devices. For example, the PCC 1 may be able to cause a monitoring event, such as the measurement and recording of non-invasive blood pressure by the NIBP. The PCC 1 may, in some embodiments, have the ability to control the output of the Infusion Pump (IVᵢ), for example to increase or decrease the material provided to the patient by the pump.

In some embodiments, a PCC 1, may include a device input/output (I/O) panel. The input/output panel provides an physical interface for external devices and information systems into and out of the system. The I/O panel may contain multiple standard connections for a variety of medical devices, clinical information systems and video, preferably with a capability to easily “hot swap” devices. The I/O panel may contain emergency and manual override switches which are assessable in the clinical environment. The I/O panel preferably is compact and sealed so as to be capable of operating in the clinical environment, including, for example, an operating room. The I/O panel may capable of taking data from a variety of monitoring devices, and receiving waveform, discrete, and/or episodic data.

The I/O panel may have different connection plates for customization in the clinical environment. These connections would include but not limited to USB, RJ-45, and RJ-232 connectors. In some embodiments, the I/O panel has a modular design, which allows different interfaces to be provided to the panel, as needed in a particular environment. Each of the interfaces may be associated with one or more medical devices.

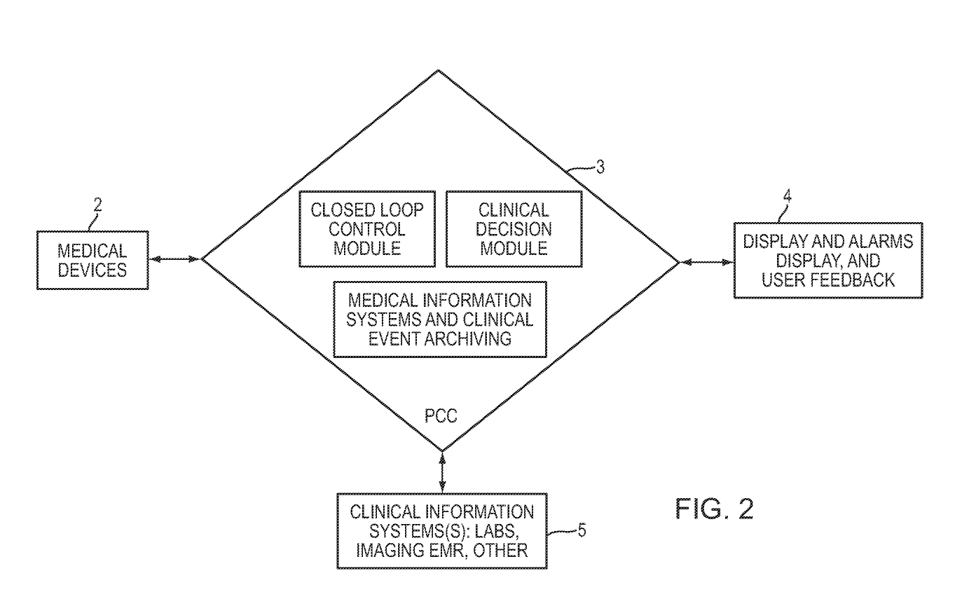

Referring to FIG. 2, the I/O panel also may have a touch screen which would allow for display at the bedside, to enable input by clinicians of trends, event tags and recordings. This display automatically displays a selected set of specific data during an event for instant communication to the clinical staff. This touch screen may be the same or different from a display unit 4 which may provide display, alarms output, and user configuration and input.

In one embodiment, the PCC includes the I/O panel and three additional modules 3, each capable of operating independently. These modules are a closed loop control module (CLC), clinical decision module (CD), and medical information system and clinical event archiving module (MIS/CEA). These modules are described further below.

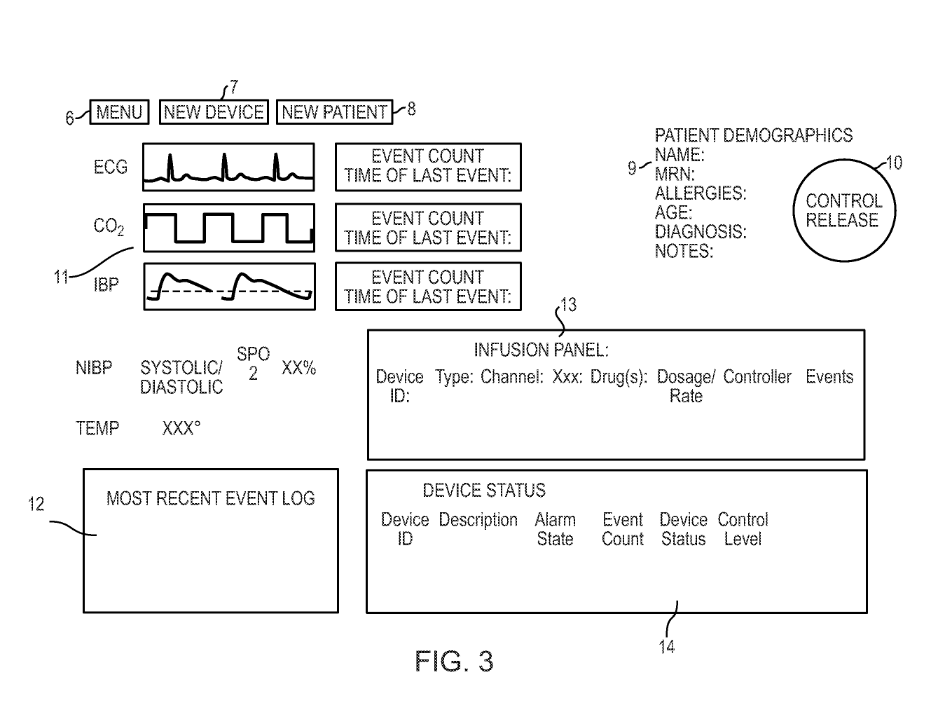

Referring to FIG. 3, an exemplary display may be visible in a patient room and/or available remotely. In this exemplary display, there are three buttons at the top: menu 6, new device 7, and new patient 8. The menu button 6 allows a clinician to set preference and rules for the system. There may security features to control levels of what can and cannot be changeable based on the clinical position. A new device option 7 allows addition of a new item of equipment. The system may have a library of interfaces which enables devices to be plugged in and added, preferably without resetting the system. It may be possible to swap failed or add new devices depending on the patient status. The new patient option 8 allows the system to attach to a new patient, with new demographic and patient data obtained from electronic medical record systems 5.

A patient and demographics display screen 9 provides a display of relevant data. The patient specific display may be a customizable display module depending on the requirements of the patients and clinician preference. For example, in addition to information such as name, and age, allergies, and so forth, it may include special instructions for the patient.

A control release button 10 may be a safety interlock that will release control of all devices such that the devices immediately begin running as individual systems. This may be useful in an emergency situation, or other circumstances.

A physiological data display 11 may be where physiological data of attached devices is stored and displayed. This display also may show events on each waveform and the time of the event. When a users touches a button it may display the events and current and/or past waveforms as configured.

A most recent event log 12 may include a time sequence of each event when the user selects the specific event all physiological data of the event occurs on the screen as well as current physiological data. A most recent event log 12 may be a time stamp description of events which are recorded in the system. Events can be defined as any change, from a button push, alarm, or change in physiological data.

In some embodiments, an infusion panel display 13 may appear when an infusion pump is plugged in. The infusion pump panel 13 records the device ID, type of pump, channel or channels, the current channel status, pharmaceuticals that are being infused, dosage, and rate. Information from the infusion pump also may include the device that is the controller or monitoring device and the event count on that specific device and channel.

A device status portion 14 may show devices attached, what they are doing, and if they are being controlled or triggered by another device. This may also record errors, alarms, or other information from the devices. For example, the device status screen 14 may show the devices that are attached, and which devices are being monitored and/or integrated with another device. The display also may provide error codes, network connects of each medical device, and so forth.

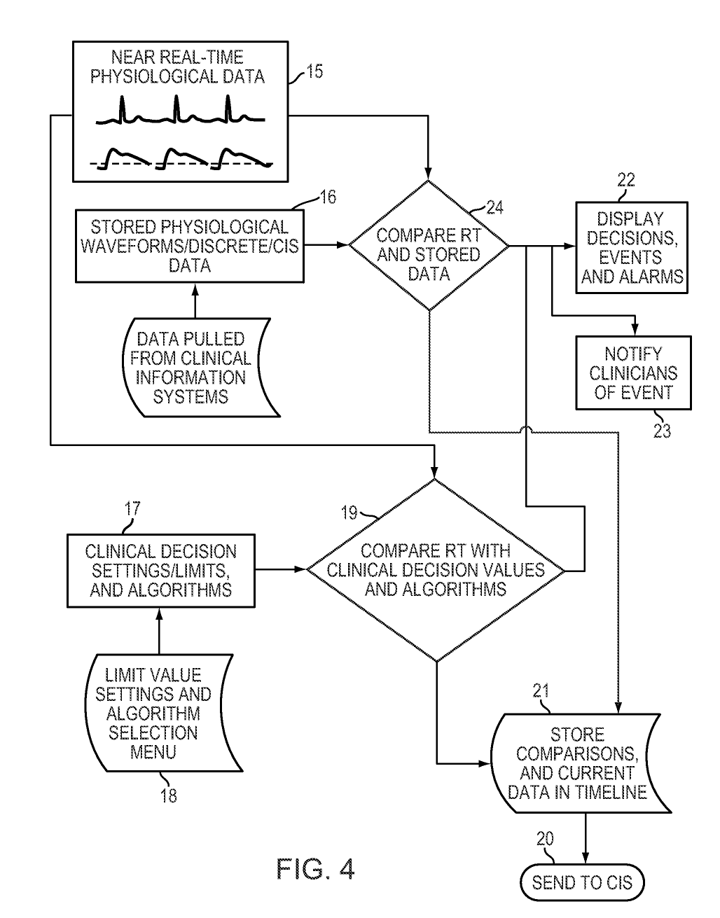

Referring to FIG. 4, a clinical decision module monitors minimum and maximum physiological monitor events, which can be set by the clinician. This portion of the system also may implement advanced clinical decision algorithms and provide diagnostic information to a clinician. This module also may generate and/or validate alarms using information from multiple devices, the medical information system and/or clinical event archiving module.

In some implementations, data 15 may be imported from medical devices, the electronic medical record and previously stored data. The system may scan an EMR for drug allergies, the date and time of previous surgical events, and potentially important information such as implantable devices. It may acquire pre-surgical testing waveforms and discrete data.

Discrete data imported from an EMR 16 may be the average of a selected time frame or the last value which was measured. These discrete values may be used as the historical baseline for comparison of real-time and stored data 24. The historical baseline and the discrete value numbers may then be used to calculate percentage changes over clinician set times.

There also may be alarm values set 17 to alert a clinician of changes. For example, episodic data may be continuously monitored for errors and alarms. These values may be compared 19 against settings specifically designated, and in some embodiments, default algorithms and automated waveform diagnostics may also be used to make periodic waveform analysis. Alarm levels and triggers also may be customizable 18.

When a device output triggers an alarm 22, this system may provide real time statistics of relevant information in one location. This allow for troubleshooting of events. The combination of alarms and clinical decision data allows for intelligent alarms. For example, clinicians may be provided with a clear past and present set of data and alerts to assist them in determining where a problem is located. This may include smart alarm technology that determines the level of alarms, as well as takes measures before the clinical staff arrives at a bedside, and possibly pausing of medical devices. Alarms can be provided to a remote monitoring station, and/or a physician pager 23.

### EXAMPLE 1

A demonstrative example of an algorithm used in the system involves an infusion pump, SPO2 and periodic NIBP taken every 30 minutes prior to drug injection. A patient's noninvasive blood pressure (NIBPB) and pulse oxide (SPO2B) are taken at the time that IV is started. As measurements, the pulse may be compared against the previous 100 values, average and each individual pulse oximetry as well as against the baseline. The baseline changes as more and more pulse oximetry values are found. If the pulse oximetry value drops below SPO2 min, or

if SPO2ᵢ < SPO2ₘᵢₙ
THEN,
IVᵣₐₜₑ PAUSED
ALARM ON HIGH

TRANSMIT last NIBP + Alarm + Drug Dosage/Rate + SPO2ᵢ +
Potential Problem
DISPLAY, Average and Trend NIBP, Events, Infusion Module,
Trend of SPO2

IF SPO2ᵢ varies more than X % (normally a large amount)
AND NIBPᵢ < X OR NIBPᵢ > X

THEN,
IVᵣₐₜₑ PAUSE X seconds
ALARM ON HIGH

TRANSMIT last NIBP + Alarm + Drug Dosage/Rate + SPO2ᵢ +
Potential Problem
DISPLAY Average and Trend NIBP, Events, Infusion Module,
Trend of SPO2

IF SPO2ᵢ varies more than X % (normally a large amount)
AND NIBPᵢ = NIBP_{base} ± X %

ALARM ON LOW
CONTROL NIBPᵢ₊ᵢ completed

TRANSMIT NIBPᵢ₊₁ + ALARM + Drug Dosage/Rate +
SPO2 + Potential Problem
DISPLAY Average and Trend NIBP, Events, Infusion Module,
Trend of SPO2

“Check SPO2 Connection”

### EXAMPLE 2

Another demonstrative example involves a patient who goes into the emergency department complaining of chest pains. A diagnostic ECG is taken, but appears normal. The patient is showing signs of discomfort therefore she is held for observation. The patient is hooked up to a continuous 5 lead ECG. The system collects 10 to 15 seconds of continuous ECG data every 2 minutes and compares it to the original ECG taken upon triage in the ER. The algorithm utilized to determine if there is a potential decline in the patient's health is:

IF ECGᵢ₊₁ ± X % ≠ ECGᵢ ± X %
DIAGNOSTIC ALGORITHM: ON
SEVERITY RANKED = s
If s = not severe
ALARM Medium
If s = severe
ALARM Low

DISPLAY: ECGᵢ, ECGᵢ₊₁, measurement changes
TRANSMIT: ECGᵢ, ECGᵢ₊₁, measurement changes

This data may then be sent to the MIS/CEA module with an event timeline 20, 21.

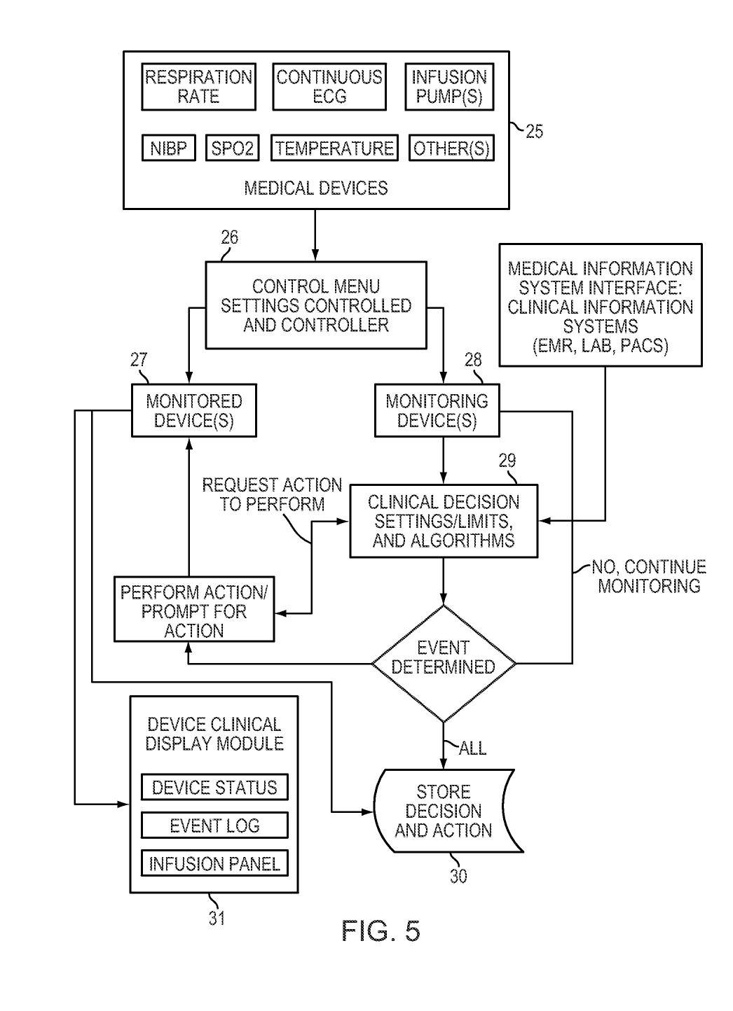

Referring to FIG. 5, a closed loop control module allows for information of one device to monitor or control the activity of another. For example, this may involve requesting the monitored device to activate at a certain phase of a waveform detected by the monitoring device. This module also may determine whether patient medical information would indicate that a warning for the clinician that a potential adverse event is about to occur would be appropriate.

Embodiments of this module allow for one device to be monitored and controlled by the values of another device 25, 26. One device is designated as the monitoring device; this device is normally a device which is measuring some physiological data 28. The monitored device is normally a device that is acting on the patient such as an infusion pump or portable x-ray machine 27. There is a series of clinical decision, settings, limits and algorithms from the 28 module which assist in the monitoring and alarming of the device 29. Each of these decisions are then logged for the clinical event logging 30 at the same time the monitoring device can have the potential of forcing the monitored device to perform an event such as a pause, or take an image. All of this information then may be provided on the display 31.

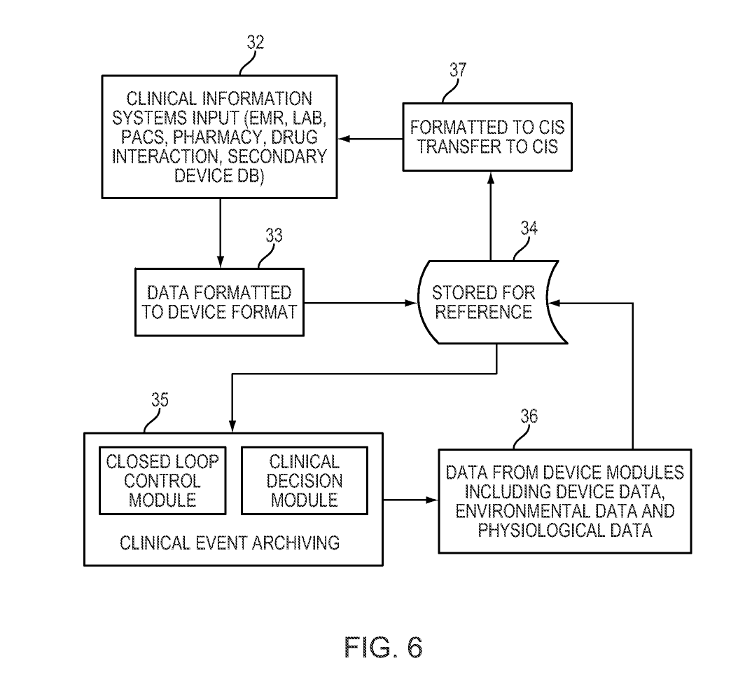

Referring to FIG. 6, a medical information systems and clinical event archiving module packages imports and exports data to the clinical information systems and other modules within the PCC and clinical event archiving portion of this module is used to establish an event timeline. The module has access to data from device modules 36, including data from device data, environmental data and/or physiological data. The module may record all events that have occurred during a clinical timeframe. This could be the entire procedure or a set time before and after an event occurring. This timeline is beneficial in training, event review, and legal situations providing a complete event history. This module would send to the MIS/CEA module for packaging sent to storage in the clinical information system.

This module may interface with the rest of the CIS. It may be capable of pulling data from the CIS which would include the EMR system, pharmacy system, lab system, PACS imaging system, as well as a drug interaction database or other commercial drug database 32. It then converts the data to a format the device can utilize 33 and is stored for referencing by the rest of the device 34 This module is responsible for maintaining an event timeline. Therefore all data and events feed through this module to receive a time stamp and sequencing 35. The timeline of events is then sent to the medical information systems portion of the module for packing to be sent to the CIS 35, 37.

What is claimed is:

1. A method for patient care, the method comprising:
receiving information from a medical device or a clinical information system;
storing the received information in a database; and
subsequently processing the stored information.

2. The method of claim 1 further comprising taking an action based on the processing of the stored information.

3. An apparatus for patient care, the apparatus comprising:
an interface for receiving information from a medical device or a clinical information system;
a database for storing the received information; and
a processor for subsequently processing the stored information.

4. The apparatus of claim 3 further comprising a second interface for taking an action based on the processing of the stored information.
